(19) United States
(12) Patent Application Publication
(10) Pub. No.: US 2026/0289744 A1
(43) Pub. Date: Sep. 24, 2026

(54) METHOD AND SYSTEM FOR DETECTING AND CORRECTING FLYING PIXEL ARTIFACTS IN AN IMAGE

(71) Applicant: E-CON SYSTEMS INDIA PRIVATE LIMITED., Chennai (IN)

(72) Inventor: S Selvamani, Chennai (IN)

(21) Appl. No.: 19/087,533

(22) Filed: Mar. 23, 2025

(51) Int. Cl. G06T 5/70; G06T 7/50

(52) U.S. Cl. CPC G06T 5/70; G06T 7/50; G06T 2207/10028

(57) ABSTRACT

The present invention discloses a method and system for detecting and correcting flying pixel artifacts in an image. The method includes receiving a depth image from a Time-of-flight camera system and acquiring a depth value for each pixel in the received depth image. Further, the method includes dynamically calculating a threshold value for each pixel based on the acquired depth value of the pixel and identifying a target pixel as a flying pixel based on the depth information of neighboring pixels. The method further includes modifying the depth value of the identified target pixel with an appropriate depth value to correct the flying pixel artifacts. The modified depth value is estimated based on at least one of mean pair of depth values from neighboring pixels or an optimum median depth value of neighboring pixels.

### FIELD OF THE INVENTION

The present invention relates to 3D depth sensing technologies, specifically Time-of-Flight (TOF) cameras used for generating depth images. The present invention proposes a method and system for detecting and correcting flying pixel artifacts in depth images.

### BACKGROUND OF THE INVENTION

The following description of related art is intended to provide background information pertaining to the field of the present disclosure. This section may include certain aspects of art that may be related to various aspects of the present disclosure. However, it should be appreciated that this section be used only to enhance the understanding of the reader with respect to the present disclosure, and therefore, unless otherwise indicated, it should not be assumed that any of the approaches described in this section qualify as prior art merely by virtue of their inclusion in this section.

Time-of-Flight (TOF) cameras estimate depth by measuring the round-trip time or phase shift of infrared (IR) light reflected from objects. Each pixel in a TOF sensor calculates a depth value based on this measurement. However, TOF sensors suffer from an inherent limitation where they generate false depth information at object edges, known as flying pixel artifacts.

This issue occurs when a pixel captures reflected light from multiple surfaces at different depths, leading to an intermediate depth value rather than an accurate representation of the foreground or background. In TOF cameras, this results in depth discontinuities, affecting the accuracy of depth maps and applications that rely on them.

Flying pixel artifacts pose a significant challenge in various applications, including autonomous mobile robots (AMRs), augmented reality (AR), and 3D reconstruction. For instance, in AMRs, flying pixel artifacts may create false obstacles, causing unnecessary path deviations or navigation failures.

Several methods have been proposed to mitigate flying pixel artifacts, but each has notable limitations. One such method is edge-based filtering, which detects object edges in an IR image and removes the corresponding pixels in the depth map. However, this method relies on the availability of a high-quality IR image and often results in the removal of valid depth pixels, thus reducing the overall accuracy of the scene.

Another existing technique is Micro-Lens Masking, where a micro-lens mask is placed over individual TOF sensor pixels to minimize the effect of flying pixel artifacts. While this reduces some false depth information, it requires hardware modifications and offers only partial filtering, leaving residual flying pixels in the depth image.

Therefore, there is a need for an improved technique that can effectively detect and correct flying pixel artifacts without requiring hardware modifications or causing significant data loss.

### SUMMARY OF THE INVENTION

The present invention overcomes these challenges by introducing a dynamic threshold-based method for detecting and correcting flying pixel artifacts without requiring additional hardware modifications. Instead of relying on external image sources or pre-defined edge detection, the proposed method dynamically determines a threshold value for each pixel based on its depth information and compares it with the depth deviation value estimated from its neighboring pixels. This adaptive approach ensures accurate identification of flying pixel artifacts while preserving valid depth information, making it suitable for real-time applications and improving depth accuracy in TOF-based imaging systems.

According to the first aspect of the present disclosure, a method for detecting and correcting flying pixel artifacts in an image comprises receiving a depth image from an image sensor of a Time-of-Flight camera system, in which the depth image includes one or more flying pixels. The method comprises acquiring a depth value for each pixel in the received depth image and dynamically calculating a threshold value for each pixel based on the acquired depth value for each pixel. The method further comprises identifying a target pixel as a flying pixel based on the depth values of neighboring pixels. The method of identifying the target pixel as the flying pixel comprises: obtaining the depth values of neighboring pixels surrounding the target pixel, comparing the obtained depth values of the neighboring pixels with the depth value of the target pixel to estimate a depth deviation value, comparing the estimated depth deviation value with a dynamically determined threshold value of the target pixel, and , identifying the target pixel as the flying pixel if the depth deviation value exceeds the dynamically determined threshold value of the target pixel, and modifying the depth value of the identified target pixel with an appropriate depth value to correct the flying pixel artifacts. The modified depth value is estimated based on at least one of a mean pair of depth values from neighboring pixels or an optimum median depth value of neighboring pixels.

In some aspects, the received depth image with flying pixels comprises either a two-Dimensional (2D) depth image or a three-Dimensional (3D) depth image.

In some aspects, obtaining the depth values of the neighboring pixels from a 2D depth image comprises using a 2D image kernel to select neighboring depth information.

In some aspects, obtaining the depth values of the neighboring pixels for a 3D depth image comprises using a K-Dimensional Tree (KDTree) to select the neighboring pixels based on their spatial proximity.

In some aspects, the appropriate depth value is estimated using a best-neighbour-pair mean correction method or a median reconstruction method.

In some aspects, the threshold value of each pixel is dynamically determined based on the depth value of the target pixel.

According to a second aspect of the present disclosure, a system for detecting and correcting flying pixel artifacts in an image is disclosed. The system comprises an image sensor, a processing unit, a display unit and a computer-readable storage medium storing a set of computer-readable instructions that, when executed, cause the processing unit to: receive a depth image from an image sensor in which the depth image includes one or more flying pixels, acquire a depth value for each pixel in the received depth image, dynamically calculate a threshold value for each pixel based on the acquired depth value of the pixel, and identify a target pixel as a flying pixel based on the depth information of neighboring pixels. The system for identifying the pixel as a flying pixel comprises: obtaining the depth values of the neighboring pixels surrounding the target pixel, comparing the obtained depth values of the neighboring pixels with the depth value of the target pixel to estimate a depth deviation value, comparing the estimated depth deviation value with a dynamically determined threshold value of the target pixel, and identifying the target pixel as a flying pixel if the estimated depth deviation value exceeds a dynamically determined threshold value of the target pixel, and modifying the depth value of the identified target pixel with an appropriate depth value to correct the flying pixel artifacts. The modified depth value is estimated based on at least one of the mean pair of depth values from neighboring pixels or an optimum median depth value of neighboring pixels.

According to a third aspect of the present disclosure, a computer program product comprising a non-transitory computer-readable medium, having thereon a computer program comprising program instructions, is disclosed. The computer program is loadable into a data processing unit and configured to cause execution of the method when the computer program is run by the data processing unit.

The present invention provides a method and system for detecting and correcting flying pixel artifacts in depth images, offering several advantages over conventional techniques.

One advantage of the present invention is that it does not require any hardware modifications to the Time-of-Flight (TOF) camera system. Unlike micro-lens masking techniques, which necessitate physical changes to the sensor, the proposed method is implemented through software-based processing, making it adaptable for integration with existing imaging systems.

Another advantage of the present invention is the use of a dynamically determined threshold value for each pixel based on its depth information. This adaptive thresholding mechanism enables accurate identification of flying pixel artifacts while minimizing false positives, thereby improving depth estimation accuracy.

The present invention further improves depth data integrity by selectively identifying and correcting only the flying pixels, without removing valid depth information. Unlike edge-based filtering techniques, which may result in the loss of true depth values at object boundaries, the proposed method ensures that valid depth data is preserved while eliminating erroneous depth artifacts.

The present invention is compatible with both two-dimensional (2D) and three-dimensional (3D) depth images, making it applicable across a wide range of TOF-based applications, including but not limited to, augmented reality (AR), autonomous mobile robots (AMRs), and 3D reconstruction systems.

The present invention further provides a software-based solution that can be seamlessly integrated with existing TOF imaging systems. The method does not require any additional hardware and can be implemented as a firmware or software update, making it a cost-effective solution for improving depth image accuracy. These and other advantages of the present invention will be apparent from the detailed description and accompanying drawings, which illustrate exemplary embodiments of the invention.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF ACCOMPANYING DRAWINGS

The above aspects, features and advantages of the disclosed technology, will be more fully appreciated by reference to the following illustrative and non-limiting detailed description of example embodiments of the present disclosure, when taken in conjunction with the accompanying drawings, in which:

FIG. 1 illustrates a flowchart of a method for detecting and correcting flying pixel artifacts in an image, according to an embodiment of the invention;

FIG. 2 illustrates a flowchart of a method to identify a target pixel as a flying pixel, according to an embodiment of the invention;

FIGS. 3a to 3b illustrate exemplary images with flying pixel artifacts and without flying pixel artifacts, according to the embodiment of the invention; and

FIG. 4 illustrates a system for detecting and correcting flying pixel artifacts in an image, according to an embodiment of the invention.

### DETAILED DESCRIPTION OF THE PREFERRED EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

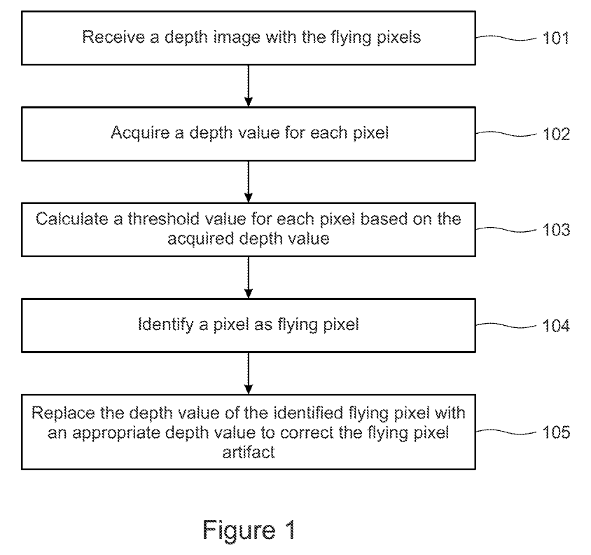

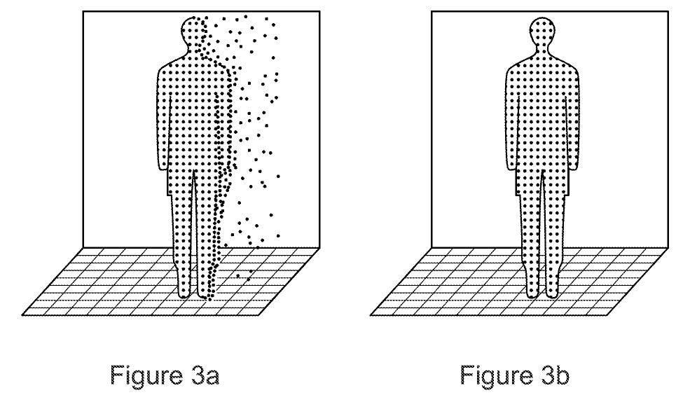

FIG. 1 illustrates a flowchart of a method for detecting and correcting flying pixel artifacts in an image, according to an embodiment of the invention. As depicted in FIG. 1, the method includes the following steps. An image sensor captures an image of a scene having multiple objects. The image sensor is a 3D depth-sensing camera or a Time-of-Flight (TOF) camera. For example, the image sensor captures the image of a scene having foreground and background objects at different distances as shown in FIG. 3a. In FIG. 3a, the person represents the foreground object and while the wall behind the person represents the background object. The image sensor calculates the depth between the foreground and background objects and generates a depth image. While generating the depth image, the image sensor estimates a false intermediate depth value at the edges of the objects, creating flying pixel artifacts when two objects (i.e. foreground and background objects) are at different distances. In FIG. 3a, the dispersed dots at the outer edges of the person in the image represent these flying pixels. The below method steps provide a method for identifying these flying pixels and dynamically correct the flying pixel artifacts.

At step 101 of FIG. 1, the depth image containing flying pixels is received from the image sensor for processing. The received depth image with the flying pixels comprises either a two-Dimensional (2D) depth image or a three-Dimensional (3D) depth image. The depth image received from the image sensor contains depth information for each pixel, with potential artifacts like flying pixel that need correction.

At step 102, a depth value for each pixel in the depth image is acquired. The depth value for each pixel in the received depth image is determined using conventional Time-of-Flight (ToF) camera techniques. These techniques involve emitting an infrared light pulse toward a scene and calculating the depth of each pixel based on the time delay (Δ𝑡) between the emission and reception of the reflected light. Alternatively, the present invention may utilize a continuous-wave ToF approach to determine the depth value for each pixel, where an amplitude-modulated signal is emitted, and the phase shift between the emitted and received signals is used to estimate depth. In some other exemplary cases, structured light techniques may also be employed to determine a depth value for each pixel. A predefined pattern is projected onto the scene, and the distortion in the pattern is analyzed to determine the depth for each pixel.

At step 103, based on the depth value of each pixel, a threshold value for each pixel is dynamically determined to ensure flying pixels are filtered optimally without affecting valid pixels. This threshold value adapts to the varying depth information across different regions of the depth image, accounting for the varying density of pixels as a function of object distance. For instance, objects closer to the camera system may require a different threshold than objects farther away due to the varying pixel density at different distances. As the depth value increases, the spatial resolution or field of view of each pixel increases, leading to a decrease in pixel density for distant objects and an increase in pixel density for closer objects. Using a fixed threshold may result in over-filtering at greater distances and under-filtering at shorter distances, thus leading to the loss of valid data or ineffective flying pixel removal. Lower thresholds may be suitable for shorter distances but may cause significant loss of detail at longer distances due to sparse points. Conversely, higher thresholds minimize depth loss at farther distances but are ineffective in removing denser points in nearer regions. To address this, the present invention dynamically calculates the optimum threshold for each pixel based on its depth value, ensuring that flying pixels are filtered effectively without affecting valid pixels.

In some examples, the dynamic determination of the threshold value for each pixel can further be refined by considering additional factors, such as the camera's depth range, focal length, and pixel size. These parameters, when available, can be incorporated to calculate more accurate threshold value, helping to better adapt to specific camera characteristics or scene conditions.

The dynamically calculated threshold value ensures that depth variations, such as those occurring at edges or boundaries between objects, are effectively detected as flying pixels while preserving valid data in the image. This threshold value is recalculated during image processing for each pixel in real time to adapt to changing depth values within the scene.

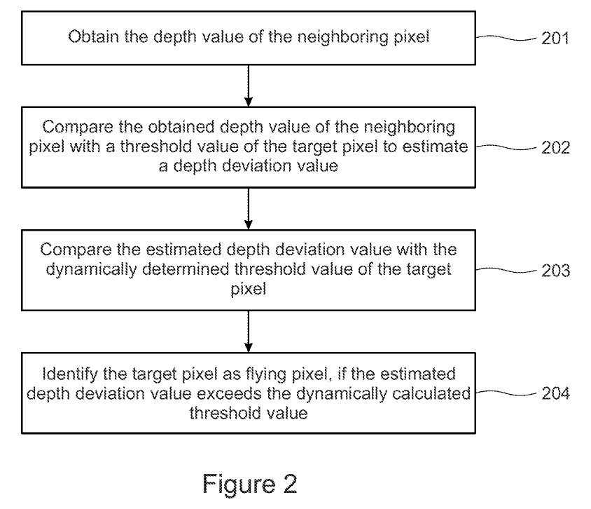

At step 104, the process of identifying flying pixels is initiated. FIG. 2 shows the detailed method involved in detecting whether a pixel is a flying pixel. This method involves comparing the depth value of each pixel with those of its neighboring pixels and determining if the pixel’s depth deviates significantly, indicating flying pixel artifacts.

Once the flying pixels are identified, the depth value of the flying pixel is modified at step 105 to remove the flying pixel. The correction is performed by estimating an appropriate depth value based on the neighboring pixels. The method may use the mean pair or optimum median depth value of the neighboring pixels for this reconstruction. The mean pair method calculates the average depth of the nearest valid neighboring pixels, while the optimum median method selects the median depth values from the valid neighbours, which is less sensitive to outliers.

The selected corrected depth value is used to modify the flying pixel’s depth value, ensuring that the corrected depth information remains consistent with the depth values of the neighboring pixels and does not introduce new flying pixels. FIG. 3b illustrates the depth image after the removal of flying pixel artifacts.

In some implementations, alternative correction algorithms can be employed, such as neighbour duplication, where the depth values of neighboring pixels are directly copied to replace the flying pixel's depth value. Another correction algorithm could be min-max algorithms, which use the minimum or maximum depth value from neighboring pixels to replace the flying pixel's depth value.

FIG. 2 illustrates a flowchart of a method for identifying a target pixel as a flying pixel, according to an embodiment of the invention. The method follows a stepwise approach to detect and classify flying pixels based on depth deviations in the depth image.

To detect flying pixels, at step 201, the depth values of the neighboring pixels surrounding the target pixel are obtained. These neighboring pixels typically include adjacent pixels in a local region, such as a 3x3 or 5x5 window. The depth values of the neighboring pixels are determined using conventional techniques, as described in step 102, where depth estimation for each pixel is performed.

At step 202, the acquired depth values of the neighboring pixels are compared with the depth value of the target pixel to estimate a depth deviation value. The depth value of the target pixel used in this step is obtained as per the method described in step 102, ensuring consistency in depth measurement across all pixels. The estimated depth deviation value represents the extent to which the target pixel’s depth differs from its neighboring pixels, indicating potential anomalies.

In some exemplary implementations, neighboring pixels for comparison are selected using a kernel of varying size, which defines the number of neighboring pixels considered when analyzing the depth consistency of the target pixel. The kernel typically forms a 3x3 or 5x5 region around the target pixel, where depth values are evaluated. A 3x3 kernel considers 8 neighboring pixels, while a 5x5 kernel includes 24 neighboring pixels, providing a broader depth context. Larger kernels allow for more robust depth deviation estimation but may reduce sensitivity to fine details.

The kernel size is camera-dependent and varies inversely with the focal length of the camera. For cameras with a wide field of view (FOV), objects appear smaller, requiring a larger kernel (e.g., 5x5) to capture a sufficient number of neighboring pixels for accurate depth deviation estimation. Conversely, for cameras with a narrow FOV, objects appear larger, and a smaller kernel (e.g., 3x3) is sufficient for reliable comparison. The focal length of the camera is obtained in real-time, and the optimum kernel size is dynamically determined to enhance the accuracy of flying pixel detection.

In some other exemplary implementations, instead of a fixed neighborhood size, the neighborhood region can be dynamically adjusted based on the depth of the target pixel. For example, pixels at greater distances may require a larger neighborhood for comparison, while closer pixels may use a smaller neighborhood to maintain precision. In some cases, spatial data structures such as KDTree may be used to select neighboring pixels in 3D space, enabling a more precise and adaptive approach to detecting flying pixel artifacts, particularly in sparse or irregular point clouds.

At step 203, the estimated depth deviation value of the target pixel is compared with its dynamically determined threshold value. The threshold value for each pixel, including the target pixel, is calculated in step 103 as part of the threshold estimation process. At step 203, the precomputed dynamic threshold value for the target pixel is retrieved and used for comparison with the depth deviation value estimated in step 202. If the depth deviation value exceeds the dynamic threshold value for the target pixel, then the target pixel is determined to have an abnormally large deviation, indicating the likelihood of being a flying pixel.

At step 204, based on the comparison in step 203, the target pixel is identified as a flying pixel if its depth deviation value exceeds the dynamically determined threshold. To ensure depth accuracy, the identified flying pixels undergo correction, where the depth values of the flying pixels are replaced or interpolated with correct depth values without recreating any flying pixels. This correction process helps to refine the depth image by removing erroneous depth values while preserving valid depth information.

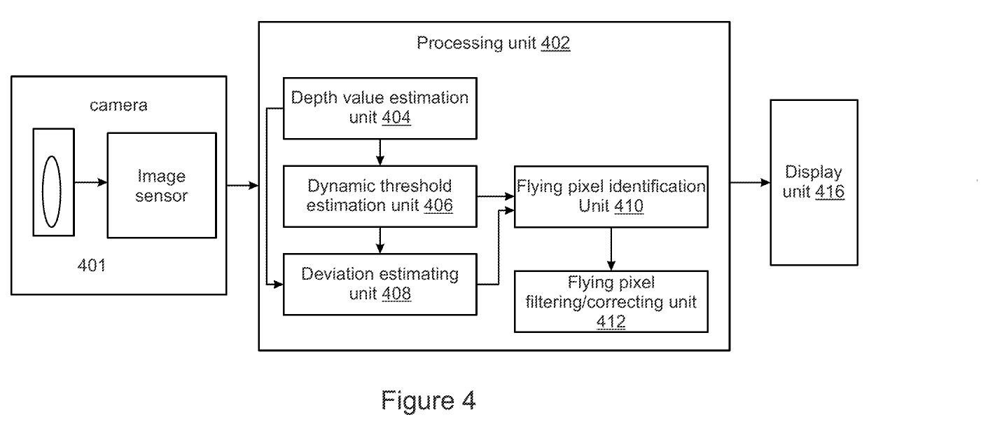

FIG. 4 illustrates a block diagram of a system for detecting and correcting flying pixel artifacts in an image, according to an embodiment of the invention. As depicted in FIG. 4, the system includes an image sensor 401, a processing unit 402 and a display unit 416. The image sensor 401 is responsible for capturing a three-dimensional (3D) depth map of the scene containing multiple objects. The image sensor may be a 3D depth-sensing camera or a Time-of-Flight (TOF) camera. For example, the image sensor captures the image of a scene with foreground and background objects at different distances, as shown in FIG. 3a.

The image sensor 401 emits infrared (IR) light and measures the time it takes for the light to return after reflecting off objects in the scene. This time-of-flight information is then used to estimate the distance of each pixel from the camera, generating a depth image where each pixel represents a specific depth value. While estimating the depth image, the image sensor may erroneously assign false intermediate depth values at object edges, creating flying pixel artifacts when two objects are at different distances.

The processing unit 402, communicatively coupled to the image sensor 401, receives the depth image from the image sensor 401 and processes it to identify and correct flying pixel artifacts. The processing unit 402 comprises a Depth Value Estimation Unit 404, a Dynamic Threshold Estimation Unit 406, a Deviation Estimating Unit 408, a Flying Pixel Identification Unit 410, and a Flying Pixel Filtering/Correcting Unit 412 for correcting flying pixel artifacts.

In some embodiments, a memory, connected to processing unit 402, stores intermediate and processed data utilized by various functional units, including the Depth Value Estimation Unit 404, the Dynamic Threshold Estimation Unit 406, the Deviation Estimating Unit 408, the Flying Pixel Identification Unit 410, and the Flying Pixel Filtering/Correcting Unit 412. The memory may include any computer-readable medium or computer program product known in the art, such as volatile memory (e.g., Static Random-Access Memory (SRAM) and Dynamic Random-Access Memory (DRAM)) or non-volatile memory (e.g., Read-Only Memory (ROM), Erasable Programmable ROM (EPROM), Electrically Erasable and Programmable ROM (EEPROM), flash memories, hard disks, optical disks, and magnetic tapes).

Depth Value Estimation Unit 404 receives the depth image with the flying pixel from the image sensor 401 and estimates a depth value for each pixel in the depth image. Depth Value Estimation Unit 404 transforms raw time-of-flight (TOF) measurements into refined depth values for each pixel. In some examples, the Depth Value Estimation Unit 404 receives either a two-Dimensional (2D) depth image or a three-Dimensional (3D) depth image and performs preprocessing steps such as noise filtering to improve the quality of the depth image before acquiring the depth values.

The Dynamic Threshold Estimation Unit 406 calculates an optimal threshold for each pixel based on the depth value of the pixel and its surrounding context. The optimal threshold varies dynamically, allowing the system to adapt to different distances and variations in depth across the scene. The Dynamic Threshold Estimation Unit 406 ensures that flying pixel artifacts are filtered out effectively without disturbing valid depth values.

In some examples, the Dynamic Threshold Estimation Unit 406 further refines threshold determination by incorporating additional camera parameters, such as depth range, focal length, and pixel size. These parameters, when available, can be incorporated to calculate more accurate thresholds, improving adaptation to specific camera characteristics or scene conditions. The dynamically determined threshold ensures that depth variations, such as those occurring at edges between objects, are effectively detected as flying pixel artifacts while preserving valid data in the image. This threshold is recalculated in real time during image processing for each pixel to ensure adaptability to changing scene depth values.

The Deviation Estimating Unit 408 chooses a target pixel and retrieves its depth value from the Depth Value Estimation Unit 404. Additionally, Deviation Estimating Unit 408 retrieves the depth values of neighboring pixels surrounding the target pixel from the Depth Value Estimation Unit 404. The set of neighboring pixels typically forms a local region, such as 3×3 or 5×5 window.

The Deviation Estimating Unit 408 compares the depth value of the target pixel with those of its neighboring pixels to compute a depth deviation value, representing the extent of depth inconsistency.

In some exemplary implementations, the Deviation Estimating Unit 408 selects neighboring pixels using a kernel of varying size, which defines the comparison region. The kernel typically forms 3×3 or 5×5 region around the target pixel, where depth values are evaluated. A 3×3 kernel considers eight neighboring pixels, whereas a 5×5 kernel includes 24 neighboring pixels, providing a broader depth context. Larger kernels enhance robustness in depth deviation estimation but may reduce sensitivity to fine details.

The kernel size is dynamically determined based on the camera’s focal length and field of view (FOV). For cameras with a wide FOV, a larger kernel (e.g., 5×5) is required to capture sufficient neighboring depth data. Conversely, for cameras with a narrow FOV, a smaller kernel (e.g., 3×3) is required to capture sufficient neighboring depth data.

Alternatively, rather than using a fixed kernel size, the Deviation Estimating Unit 408 dynamically adjusts the neighborhood size based on the depth of the target pixel. Pixels at greater distances may require a larger neighborhood for comparison, while closer pixels use a smaller neighborhood to maintain accuracy. In some implementations, spatial data structures such as KDTree may be employed to select neighboring pixels in 3D space, facilitating more precise flying pixel detection, particularly in sparse or irregular point clouds.

The Flying Pixel Identification Unit 410 determines whether a pixel is a flying pixel by comparing the depth deviation value with its corresponding dynamic threshold. The dynamic threshold for each pixel, including the target pixel, is precomputed by the Dynamic Threshold Estimation Unit 406. The Flying Pixel Identification Unit 410 retrieves the threshold value of the target pixel and compares it with the estimated depth deviation value. If the depth deviation value exceeds the dynamic threshold value of the target pixel, the pixel is flagged as a flying pixel, indicating that its depth value is unreliable.

The Flying Pixel Filtering/Correcting Unit 412 corrects identified flying pixel artifacts by modifying their depth values using valid depth data from neighboring pixels. The Flying Pixel Filtering/Correcting Unit 412 applies various correction algorithms, such as the mean pair or optimum median depth value of neighboring pixels, to refine the depth value of the flying pixel while preventing the introduction of new artifacts. The mean pair method computes the average depth of the closest valid neighbors, whereas the optimum median method selects the median depth value, reducing sensitivity to outliers. This correction process enhances the accuracy of the depth image and mitigates artifacts caused by flying pixels.

Although the present invention has been described in considerable detail with reference to certain preferred embodiments and examples thereof, other embodiments and equivalents are possible. Even though numerous characteristics and advantages of the present invention have been set forth in the foregoing description, together with functional and procedural details, the disclosure is illustrative only, and changes may be made in detail, especially in terms of the procedural steps within the principles of the invention to the full extent indicated by the broad general meaning of the terms. Thus, various modifications are possible of the presently disclosed system and process without deviating from the intended scope of the present invention.

What is claimed is:

1. A method for detecting and correcting flying pixel artifacts in an image, the method comprises,
receiving a depth image from an image sensor of a Time-of-flight camera system, wherein the depth image includes one or more flying pixels;
acquiring a depth value for each pixel in the received depth image;
dynamically calculating a threshold value for each pixel based on the acquired depth value for each pixel;
identifying a target pixel as a flying pixel based on the depth values of neighboring pixels, wherein identifying the target pixel as the flying pixel comprises:
obtaining the depth values of the neighboring pixels surrounding the target pixel;
comparing the obtained depth values of the neighboring pixels with the depth value of the target pixel to estimate a depth deviation value;
comparing the estimated depth deviation value with a dynamically determined threshold value of the target pixel; and
identifying the target pixel as the flying pixel, in an event the depth deviation value exceeds the dynamically determined threshold value of the target pixel; and
modifying the depth value of the identified target pixel with an appropriate depth value to correct the flying pixel artifacts, wherein the modified depth value is estimated based on at least one of a mean pair of depth values from neighboring pixels or an optimum median depth value of neighboring pixels.

2. The method as claimed in claim 1, wherein the received depth image with flying pixels comprises either a two-Dimensional (2D) depth image or a three-Dimensional (3D) depth image.

3. The method as claimed in claim 1, wherein obtaining the depth values of the neighboring pixels from a 2D depth image comprises using a 2D image kernel to select neighboring depth information.

4. The method as claimed in claim 1, wherein obtaining the depth values of the neighboring pixels for a 3D depth image comprises using a K-Dimensional Tree (KDTree) to select the neighboring pixels based on their spatial proximity.

5. The method as claimed in claim 1, wherein the appropriate depth value is estimated using a best neighbor-pair mean correction method or a median reconstruction method.

6. The method as claimed in claim 1, wherein the threshold value of each pixel is dynamically determined based on the depth value of the target pixel.

7. A system for detecting and correcting a flying pixel artifacts in an image, the system comprises:
an image sensor;
a processing unit;
a display unit; and
a computer readable storage medium storing a set of computer readable instructions that when executed by the processing unit, cause the processing unit to:
receive a depth image from an image sensor, wherein the depth image includes one or more flying pixels;
acquire a depth value for each pixel in the received depth image;
dynamically calculate a threshold value for each pixel based on the acquired depth value of the pixel;
identify a target pixel as a flying pixel based on the depth values of neighboring pixels, wherein identifying the target pixel as the flying pixel comprises:
obtaining the depth values of neighboring pixels surrounding the target pixel;
comparing the obtained depth values of the neighboring pixels with the depth value of the target pixel to estimate a depth deviation value;
comparing the estimated depth deviation value with a dynamically determined threshold value of the target pixel; and
identifying the target pixel as the flying pixel, in an event the depth deviation value exceeds the dynamically determined threshold value of the target pixel; and
modify the depth value of the identified target pixel with an appropriate depth value to correct the flying pixel artifacts, wherein the modified depth value is estimated based on at least one of the mean pair of depth values from neighbouring pixels or an optimum median depth value of neighboring pixels.

8. The system as claimed in claim 7, wherein the received depth image with the flying pixels comprises either a two-Dimensional (2D) depth image or a three-Dimensional (3D) depth image.

9. The system as claimed in claim 7, wherein obtaining the depth values of the neighboring pixels from a 2D depth image comprises using a 2D image kernel to select neighboring depth information from the 2D depth image.

10. The system as claimed in claim 7, wherein obtaining the depth values of the neighboring pixels for a 3D depth image comprises using a K-Dimensional Tree (KDTree) to select the neighboring pixels based on their spatial proximity.

11. The system as claimed in claim 7, wherein the appropriate depth value is estimated using a best-neighbor-pair mean correction method or a median reconstruction method.

12. The system as claimed in claim 7, wherein the threshold value of each pixel is dynamically determined based on the depth value of the target pixel.

13. A computer program product comprising a non-transitory computer readable medium, having thereon a computer program comprising program instructions, the computer program is loadable into a data processing unit and configured to cause execution of the method according to claim 1 when the computer program is run by the data processing unit.
